(19) United States
(12) Patent Application Publication
(10) Pub. No.: US 2024/0411432 A1
(43) Pub. Date: Dec. 12, 2024

(54) VIDEO DISPLAY METHOD AND APPARATUS, AND ELECTRONIC DEVICE AND STORAGE MEDIUM

(71) Applicant: BEIJING ZITIAO NETWORK TECHNOLOGY CO., LTD., Beijing (CN)

(72) Inventors: Zhanchen ZHANG, Beijing (CN); Xiu PEI, Beijing (CN)

(21) Appl. No.: 18/552,306

(22) PCT Filed: Mar. 15, 2022
(86) PCT No.: PCT/CN2022/080898

§ 371 Date: Sep. 25, 2023

(30) Foreign Application Priority Data
Mar. 26, 2021 (CN) 202110328322.9

(51) Int. Cl. G06F 3/0484; G06F 3/0481

(52) U.S. Cl. CPC G06F 3/0484; G06F 3/0481

(57) ABSTRACT

Provided are a video display method and apparatus, an electronic device, and a storage medium. The video display method includes receiving a first trigger operation acting on a first message display region on a session page, where the first message display region is displayed in a first display style, and video description information of a first target video is displayed in the first message display region; and in response to the first trigger operation, switching the first message display region from the first display style to a second display style and playing the first target video in the switched first message display region.

This is a U.S. National Stage Application, filed under 35 U.S.C. 371, of International Patent Application No. PCT/CN2022/080898, filed on Mar. 15, 2022, which claims priority to Chinese Patent Application No. 202110328322.9 filed with the China National Intellectual Property Administration (CNIPA) on Mar. 26, 2021, the disclosures of which are incorporated herein by reference in their entireties.

### TECHNICAL FIELD

The present disclosure relates to the field of computer technologies, for example, a video display method and apparatus, an electronic device, and a storage medium.

### BACKGROUND

When having a conversation with other users, a user may send a video message to other users having a conversation with the user or receive a video message sent by other users.

However, in the related art, the video message received and/or sent by the user is generally displayed in a fixed display style on a session page, and the display method is relatively single, which cannot satisfy the requirements of the user.

### SUMMARY

The present disclosure provides a video display method and apparatus, an electronic device, and a storage medium, so as to provide a user with various display manners of a video message.

The present disclosure provides a video display method. The video display method includes the steps described below.

A first trigger operation acting on a first message display region on a session page is received, where the first message display region is displayed in a first display style, and video description information of a first target video is displayed in the first message display region.

In response to the first trigger operation, the first message display region is switched from the first display style to a second display style and the first target video is played in a switched first message display region.

The present disclosure further provides a video display apparatus. The video display apparatus includes a receiving module and a first switching module.

The receiving module is configured to receive a first trigger operation acting on a first message display region on a session page, where the first message display region is displayed in a first display style, and video description information of a first target video is displayed in the first message display region.

The first switching module is configured to, in response to the first trigger operation, switch the first message display region from the first display style to a second display style and play the first target video in a switched first message display region.

The present disclosure further provides an electronic device. The electronic device includes one or more processors and a memory configured to store one or more programs.

When executed by the one or more processors, the one or more programs cause the one or more processors to perform the preceding video display method.

The present disclosure further provides a computer-readable storage medium. The storage medium stores a computer program which, when executed by a processor, causes the processor to perform the preceding video display method.

### BRIEF DESCRIPTION OF DRAWINGS

FIG. 1 is a flowchart of a video display method according to an embodiment of the present disclosure;

FIG. 2 is a schematic diagram of a session page according to an embodiment of the present disclosure;

FIG. 3 is a schematic diagram of another session page according to an embodiment of the present disclosure:

FIG. 4 is a flowchart of another video display method according to an embodiment of the present disclosure:

FIG. 5 is a block diagram of a video display apparatus according to an embodiment of the present disclosure; and

FIG. 6 is a structural diagram of an electronic device according to an embodiment of the present disclosure.

### DETAILED DESCRIPTION

Embodiments of the present disclosure are described hereinafter with reference to the drawings. The drawings illustrate some embodiments of the present disclosure, but the present disclosure may be implemented in various manners. These embodiments are provided for ease of understanding of the present disclosure. The drawings and embodiments of the present disclosure are illustrative.

Steps described in method embodiments of the present disclosure may be performed in different sequences and/or in parallel. Additionally, the method embodiments may include additional steps and/or omit some of the illustrated steps. The scope of the present disclosure is not limited in this respect.

As used herein, the term “include” and variations thereof are intended to be inclusive, that is, “including, but not limited to”. The term “based on” is “at least partially based on”. The term “one embodiment” means “at least one embodiment”: the term “another embodiment” means “at least one another embodiment”; and the term “some embodiments” means “at least some embodiments”. Definitions of other terms are given in the description hereinafter.

Concepts such as “first” and “second” in the present disclosure are merely intended to distinguish one from another apparatus, module, or unit and are not intended to limit the order or interrelationship of the functions performed by the apparatus, module, or unit.

References to modifications of “one” or “a plurality” mentioned in the present disclosure are intended to be illustrative and not limiting: those skilled in the art should understand that “one” or “a plurality” should be understood as “one or more” unless clearly expressed in the context.

The names of messages or information exchanged between apparatuses in the embodiments of the present disclosure are only used for illustrative purposes and are not intended to limit the scope of the messages or information.

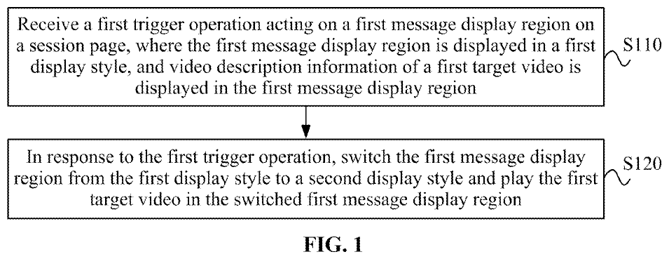

FIG. 1 is a flowchart of a video display method according to an embodiment of the present disclosure. The method may be performed by a video display apparatus. The apparatus may be implemented in software and/or hardware and may be configured in an electronic device such as a mobile phone or a tablet computer. The video display method provided in embodiments of the present disclosure is applicable to a scenario of displaying a video, for example, to a scenario of displaying a video message received and/or sent by a user on a session page. As shown in FIG. 1, the video display method provided in this embodiment may include the steps described below:

In S101, a first trigger operation acting on a first message display region on a session page is received, where the first message display region is displayed in a first display style, and video description information of a first target video is displayed in the first message display region.

The first trigger operation may be an operation of triggering a message display region (such as a conversation box, a chat box, or a chat bubble) that displays the video description information on the session page, such as an operation of clicking on the message display region that displays the video description information on the session page. Correspondingly, the first message display region may be the message display region triggered by the first trigger operation, and the message display region may be understood as a display region that displays the video description information, that is, a display region corresponding to the video message. The first target video may be a video message corresponding to the first message display region, that is, a video message to which the video description information displayed in the first message display region belongs, and the video message may be understood as a video session message.

When the user wants to watch a target video, the user may trigger the message display region that displays the video description information of the target video on the session page. Correspondingly, when detecting that the user triggers the message display region of the target video on the session page, the electronic device may use the message display region as the first message display region, determine the target video to which the video description information displayed in the message display region belongs as the first target video, and determine that the first trigger operation acting on the first message display region is received.

In this embodiment, when the user receives or sends the video message, the electronic device may display the video description information of the video message in the message display region displayed in the first display style. At this time, the message display region of the target video is displayed in the first display style on the session page, and the video description information of the target video is displayed in the message display region, where the target video includes the first target video.

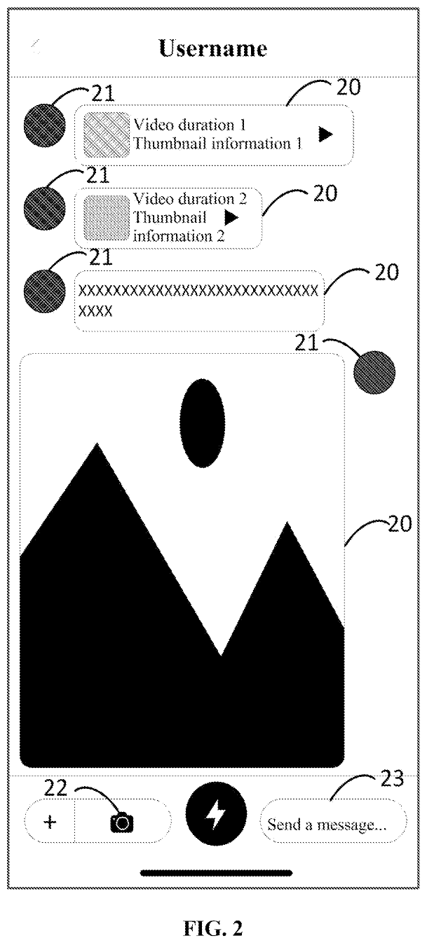

As shown in FIG. 2, the electronic device may display the message display region of each target video received and/or sent by the user in the first display style and display the video description information of the target video in the message display region. For example, the video cover, the video duration, and/or the thumbnail information of a video subtitle of the target video are displayed in the message display region of each target video. For example, when receiving the target video sent by another user, the electronic device may acquire the video description information of the target video determined by a sending end of the target video, display the message display region corresponding to the target video in the first display style, and display the video description information of the target video in the message display region. When receiving the trigger operation of the user sending the target video, the electronic device may determine the video description information of the target video, display the message display region corresponding to the target video in the first display style, display the video description information of the target video in the message display region, and send the target video and the video description information of the target video to a corresponding receiving end for display.

The target video may be understood as the video message that needs to be displayed on the session page. The target video includes the first target video and may also include a second target video and/or other target videos. The video cover of the target video may be a cover set for the target video by the user who sends the target video and may also be a cover determined by the sending end of the target video. For the cover determined by the sending end of the target video, for example, the first frame and/or key frame of the target video is determined as the video cover of the target video, or one or more video frames are randomly selected among the video frames in the first preset duration (such as the first 2 seconds) of the target video and used as the video cover of the target video, that is, the video cover of the target video may be a static cover containing only a single picture or may be a dynamic cover composed of multiple pictures. The thumbnail information of the video subtitle of the target video may be determined by the sending end of the target video. For example, before sending the target video, a sender of the target video may determine the video subtitle of the target video through voice recognition and select the preset number of words (such as the first 10 words) in the video subtitle of the target video as the thumbnail information of the video subtitle of the target video, or the sender of the target video may extract the key content (such as the abstract) of the video subtitle of the target video and use the key content as the thumbnail information of the video subtitle of the target video, which is not limited in this embodiment.

With continued reference to FIG. 2, in addition to displaying the session message in the message display region 20 on the session page, an avatar 21 of the sender of each session message may also be displayed on the session page. For example, if the session message is sent by another user to the local user, the avatar 21 of the sender of the session message may be displayed on the left side of the message display region of the session message; and if the session message is sent by the local user to another user, the avatar 21 of the sender of the session message may be displayed on the right side of the message display region of the session message. In addition, a capturing control 22 for the user to trigger to capture a video message and a message input box 23 for the user to input and publish a text message (including an emoticon) may also be set on the session page.

In S102, in response to the first trigger operation, the first message display region is switched from the first display style to a second display style and the first target video is played in the switched first message display region.

The first display style and the second display style may be display styles with different colors, shapes, and/or dimensions, that is, when the first display style is used for display and the second display style is used for display, the first message display region may have different colors, shapes, and/or dimensions. For example, the height of the first message display region displayed in the second display style may be greater than the height of the first message display region displayed in the first display style so that the second display style is convenient for the user to watch the first target video. For example, the first display style may be a conversation box (or a chat box), and the second display style may be a large card.

When receiving the first trigger operation acting on the first message display region, the electronic device may switch the display style of the first message display region from the first display style to the second display style and play the first target video in the first message display region displayed in the second display style.

In an embodiment, the step of switching the first message display region from the first display style to the second display style includes expanding the dimension of the first message display region to switch the first message display region from the first display style to the second display style.

In the preceding embodiment, when the video message that needs to be displayed on the session page exists, for example, when the video message sent by another user is received or the local user sends the video message to another user, the message display region of the video message may be displayed in a relatively small dimension on the session page, and the video description information of the target video is displayed in the message display region. When the user wants to view the video message, the message display region is expanded to a dimension suitable for displaying a video screen. Therefore, when the message display region is not expanded, the video message only needs to occupy a relatively small dimension on the session page, which can reduce the space occupied by the video message on the session page compared with the related art in which the video message is directly displayed in the form of a large card. In this manner, the session page can display a larger number of session messages (including video messages) at a time so that the user can browse a larger number of session messages through one switching operation, thereby reducing the operating costs of the user when browsing the session messages. When the message display region is expanded, the user can directly watch the video message on the session page and can continue browsing other session messages displayed on the session page without jumping to other pages, thereby improving the efficiency of the user browsing messages.

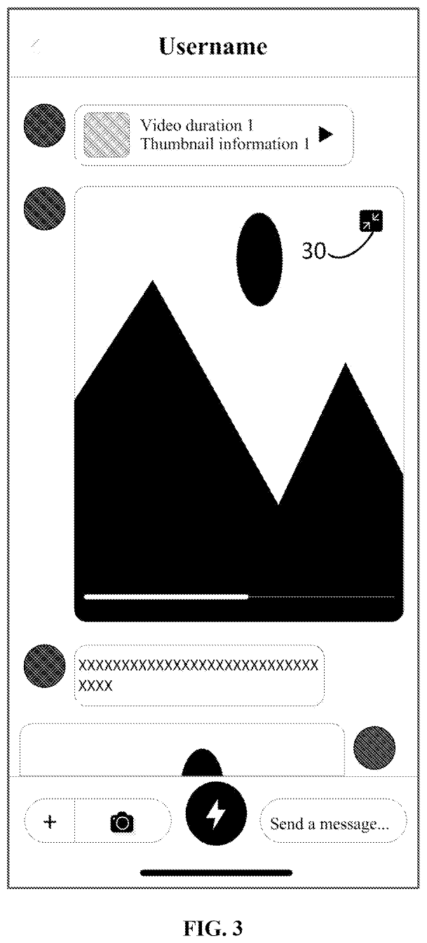

When receiving the first trigger operation acting on the first message display region of the first target video, the electronic device may expand the display dimension (including the width and/or the height) of the first message display region on the session page. For example, the first message display region is expanded to a set dimension, or the expansion dimension (that is, a dimension to which the dimension of the first message display region needs to be expanded) of the first message display region is determined according to the dimension of a video frame of the first target video, and the first message display region is expanded according to the expansion dimension. As shown in FIG. 3 (the case where the user triggers the message display region of the second session message on the session page is used as an example in the figure), after the first message display region is expanded, the first target video is played in the expanded first message display region, and the display of the video description information of the first target video in the first message display region may be stopped. Here, when the first target video is played, the subtitle (not shown in FIG. 3) of the first target video may also be displayed in the expanded first message display region (such as on the lower side of the first message display region), and the subtitle of the first target video may be determined through the voice recognition.

In this embodiment, the methods for expanding the dimension of the first message display region may be selected according to requirements. For example, when the height of the first message display region is expanded, the upper boundary line of the first message display region may be moved upward, and/or the lower boundary line of the first message display region may be moved downward; and when the width of the first message display region is expanded, the left boundary line of the first message display region may be moved leftward, and/or the right boundary line of the first message display region may be moved rightward, which is not limited in this embodiment.

When the boundary lines of the first message display region are controlled to move upward/downward, if the message display regions of other session messages are displayed above/below the first message display region on the session page, the other message display regions displayed above/below the first message display region may also be controlled to move upward/downward, so as to prevent the expanded first message display region from blocking the message display regions of other messages, which is convenient for the user to view the session messages displayed on the session page.

In an embodiment, the step of expanding the dimension of the first message display region includes moving a target boundary line of the first message display region in a direction of expanding the width of the first message display region until the target boundary line is spaced apart from a corresponding boundary line of the session page by a preset distance, where the target boundary line is a left boundary line or a right boundary line; and/or moving a lower boundary line of the first message display region downward until the dimension ratio of the first message display region matches the dimension ratio of a video frame of the first target video.

The preset distance may be a fixed distance preset by a developer or a distance determined according to the width of the session page, such as a distance proportional to the width of the message display region. The preset distance may be 0 cm, 0.2 cm, 0.5 cm, or the like. The dimension ratio of the first message display region may be the aspect ratio of the first message display region, and the dimension ratio of the video frame of the first target video may be the aspect ratio of the video frame of the first target video.

In the preceding embodiment, when the dimension of the first message display region corresponding to the first target video is expanded, the expansion dimension of the first message display region may be determined according to the dimension of the session page (or the screen dimension of the electronic device), the width of the first message display region is expanded leftward/rightward, and/or the height of the first message display region is expanded downward so that the first message display region is expanded to the expansion dimension.

For example, when receiving the first trigger operation, the electronic device may first determine the expansion width of the first message display region according to the width of the session page and the preset distance and determine the expansion height of the first message display region according to the expansion width and the aspect ratio of the video frame of the first target video. Then, whether the original width of the first message display region before expansion reaches the expansion width is determined, and when the original width does not reach the expansion width, the right boundary line of the first message display region is controlled to move rightward (for the case where the avatar of the sender of the first target video is located on the left side of the first message display region on the session page), or the left boundary line of the first message display region is controlled to move leftward (for the case where the avatar of the sender of the first target video is located on the right side of the first message display region on the session page) until the width of the first message display region reaches the expansion width. Moreover, whether the original height of the first message display region before expansion reaches the expansion height is determined, and when the original height does not reach the expansion height, the lower boundary line of the first message display region is controlled to move downward until the height of the first message display region reaches the expansion height.

The video display method provided in this embodiment includes receiving the first trigger operation acting on the first message display region on the session page, where the first message display region is displayed in the first display style, and the video description information of the first target video is displayed in the first message display region; and in response to the first trigger operation, switching the first message display region from the first display style to the second display style and playing the first target video in the switched first message display region. In this embodiment, the preceding technical solution is adopted so that different display styles can be used to display the video message, thereby improving the conversation experience of the user.

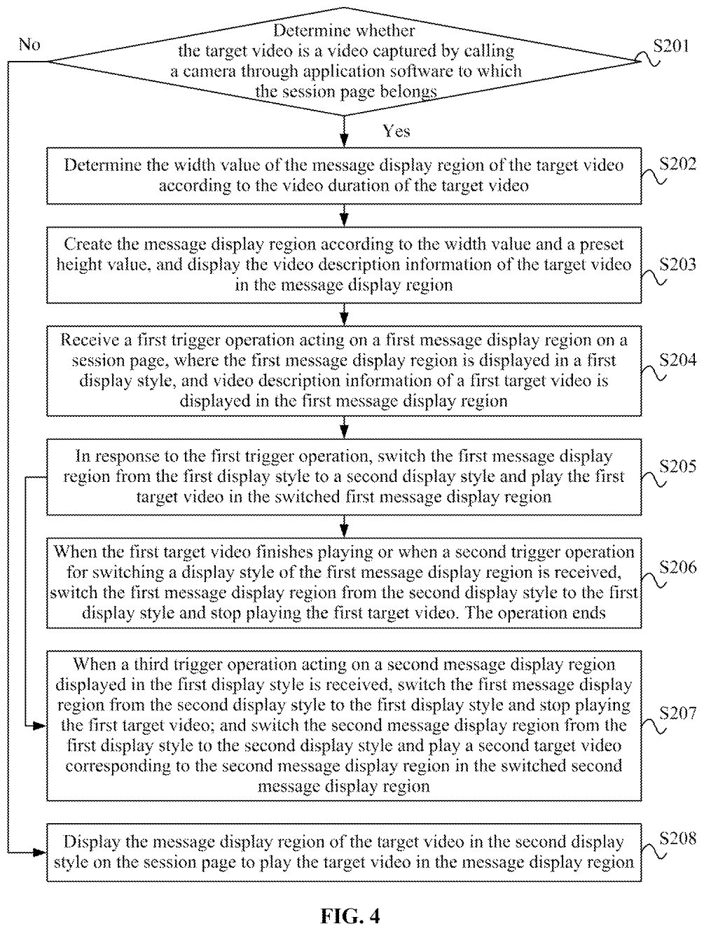

FIG. 4 is a flowchart of another video display method according to an embodiment of the present disclosure. The scheme of this embodiment may be combined with one or more of the alternative schemes of the preceding embodiments. In an exemplary embodiment, after the first target video is played in the switched first message display region, the method further includes when the first target video finishes playing or when a second trigger operation for switching a display style of the first message display region is received, switching the first message display region from the second display style to the first display style and stopping playing the first target video; or when a third trigger operation acting on a second message display region displayed in the first display style is received, switching the first message display region from the second display style to the first display style and stopping playing the first target video; and switching the second message display region from the first display style to the second display style and playing a second target video corresponding to the second message display region in the switched second message display region.

In an exemplary embodiment, the step of displaying the message display region of the target video in the first display style on the session page includes determining the width value of the message display region of the target video according to the video duration of the target video; and creating the message display region according to the width value and a preset height value.

In an exemplary embodiment, before the message display region of the target video is displayed in the first display style on the session page, the method further includes determining that the target video is a video captured by calling a camera through an application software to which the session page belongs.

In an exemplary embodiment, the video display method provided in this embodiment may further include in the case where the target video is not the video captured by calling the camera through the application software to which the session page belongs, displaying the message display region of the target video in the second display style on the session page to play the target video in the message display region.

Accordingly, as shown in FIG. 4, the video display method provided in this embodiment may include the steps described below:

In S201, whether the target video is a video captured by calling the camera through the application software to which the session page belongs is determined. If the target video is the video captured by calling the camera through the application software to which the session page belongs, S202 is performed. If the target video is not the video captured by calling the camera through the application software to which the session page belongs, S208 is performed.

The current target video to be displayed may be a video message that needs to be displayed at the current moment, such as a video message received at the current moment and/or a video message sent by the user to another user at the current moment.

In this example, the video message imported into the application software for sending and the video message directly captured by calling the camera and sent through the application software may be displayed in different manners on the session page, which is convenient for the user to distinguish between the video messages and improves the interest of the user in using the application software to call the camera to capture and send the video message.

In this step, the method for determining whether the target video is the video captured by calling the camera through the application software to which the session page belongs may be flexibly set. For example, when the current target video to be displayed is a video message sent by the local user to another user, the electronic device may determine whether the target video is the video captured by calling the camera through the application software to which the session page belongs based on the corresponding trigger operation of the user at the local end. For example, as shown in FIG. 2, if the target video is a video captured by the local user by triggering the capturing control 22 on the session page, it may be determined that the target video is the video captured by calling the camera through the application software to which the session page belongs. If the target video is not the video captured by the local user by triggering the capturing control 22 on the session page, it may be determined that the target video is not the video captured by calling the camera through the application software to which the session page belongs, and when the target video is sent to another user, the determination result of whether the target video is the video captured by calling the camera through the application software to which the session page belongs is sent to the user terminal of another user. When the current target video to be displayed is a video sent by another user to the local user, after receiving the target video, the electronic device may determine whether the target video is the video captured by calling the camera through the application software to which the session page belongs based on the determination result sent synchronously with the target video.

In S202, the width value of the message display region of the target video is determined according to the video duration of the target video.

The message display region may be a region on the session page for displaying the video description information of the target video.

In this embodiment, the width of the message display region for displaying the video description information of the target video may be set according to the video duration of the target video so that the user can determine the size relationship between the video durations of different target videos according to the widths of the message display regions corresponding to the different target videos displayed on the session page.

When the target video that needs to be displayed exists, the electronic device may acquire the video duration of the target video, determine the width value of the message display region corresponding to the video duration according to the video duration and the correspondence (or conversion relationship) between the video duration and the width value of the message display region preset by the developer, and use the width value as the width value of the message display region corresponding to the target video.

In S203, the message display region is created according to the width value and a preset height value, and the video description information of the target video is displayed in the message display region.

The height value of the message display region of the target video may be a fixed height value or a height value proportional to the page height of the session page (or the height of the screen of the electronic device) and may be set by the developer as required.

After determining the width value of the message display region corresponding to the target video, the electronic device may acquire the preset height value of the message display region corresponding to the target video, create the message display region on the session page according to the width value and the height value, and display the video description information of the target video in the message display region.

In S204, a first trigger operation acting on a first message display region on a session page is received, where the first message display region is displayed in a first display style, and video description information of a first target video is displayed in the first message display region.

In S205, in response to the first trigger operation, the first message display region is switched from the first display style to a second display style and the first target video is played in the switched first message display region. S206 or S207 is performed.

In S206, when the first target video finishes playing or when a second trigger operation for switching a display style of the first message display region is received, the first message display region is switched from the second display style to the first display style and the playing of the first target video is stopped. The operation ends.

The second trigger operation may be an operation of switching the display style of the first message display region (such as switching the first message display region back to the first display style), such as an operation of triggering a folding control in the first message display region.

In this embodiment, when the first target video finishes playing or when a trigger operation of switching the display style of the first message display region is received, the first message display region may be switched back to the first display style so that the user can quickly browse the session messages.

For example, the electronic device plays the first target video in the expanded first message display region; and after the first target video finishes playing, the electronic device automatically switches the first message display region to the first display style, for example, the dimension of the first message display region shrinks to the original dimension value before switching, the playing of the first target video in the first message display region is stopped, and the video description information of the first target video is displayed in the first message display region. Moreover/alternatively, the electronic device plays the first target video and displays a folding control 30 in the switched first message display region as shown in FIG. 3. When the user wants to switch the first message display region from the second display style to the first display style, that is, when the user wants to fold the first message display region, the user may trigger the folding control 30 displayed in the first message display region. Correspondingly, when detecting that the user triggers the folding control 30 in the first message display region, the electronic device may determine that the second trigger operation of folding the first message display region is received, and in response to the second trigger operation, restore the first message display region to the first display style before expansion.

Here, the method for shrinking the dimension of the first message display region to the original dimension value may be flexibly set. For example, the left boundary line of the first message display region may be controlled to move rightward and/or the right boundary line of the first message display region may be controlled to move leftward until the width of the first message display region shrinks to the original width value before expansion, and the upper boundary line of the first message display region may be controlled to move downward and/or the lower boundary line of the first message display region may be controlled to move upward until the height of the first message display region shrinks to the original height value before expansion. For example, the boundary line that moves during expansion may be controlled to move along a direction opposite to the direction of movement during expansion, so as to ensure that the first message display region has the same display state as that before expansion after the dimension of the first message display region shrinks to the original dimension value.

In S207, when a third trigger operation acting on a second message display region displayed in the first display style is received, the first message display region is switched from the second display style to the first display style and the playing of the first target video is stopped; and the second message display region is switched from the first display style to the second display style and a second target video corresponding to the second message display region is played in the switched second message display region. The operation ends.

In this embodiment, when playing other target videos on the session page (including the video message in the message display region displayed in the first display style and the video message in the message display region displayed in the second display style), the electronic device may automatically stop playing the first target video and fold the first message display region, so as to avoid distracting the user by playing multiple target videos at the same time, and to facilitate the user to quickly browse the session messages.

The third trigger operation may be an operation of triggering the message display region of the target video other than the first message display region when the first target video is played. Correspondingly, the second message display region may be the message display region triggered by the third trigger operation, and the second target video may be the video message corresponding to the second message display region, that is, the target video to which the video description information displayed in the second message display region belongs.

The case where a trigger operation that triggers the message display region displayed in the first display style is received during the process of playing the first target video is used as an example. The electronic device plays the first target video in the expanded first message display region and displays the video description information of the corresponding target video in the message display region corresponding to another target video on the session page. When the user wants to watch another target video, the user may trigger the message display region corresponding to the target video. Correspondingly, when detecting that the user triggers the message display region of the target video displayed on the session page, the electronic device may use the target video as the second target video, use the message display region as the second message display region, determine that the third trigger operation acting on the second message display region corresponding to the second target video is received, switch the first message display region from the second display style to the first display style in response to the third trigger operation, stop playing the first target video, switch the second message display region from the first display style to the second display style, and play the second target video in the switched second message display region.

In this embodiment, when and only when the first target video finishes playing, the trigger operation of switching the display style of the message display region of the first target video is received, and/or the trigger operation of playing other target videos on the session page is received, the playing of the first target video is stopped. Moreover, when other trigger operations are received, for example, when the user inputs and sends a new session message, when the display content on the session page is adjusted based on the sliding operation of the user, or when the first message display region moves out of the display region of the session page, the display of the first target video is continued. In this manner, when watching the first target video, the user can continue to browse other session messages on the session page and/or perform a conversation or chat, thereby improving the user experience.

In S208, the message display region of the target video is displayed in the second display style on the session page so as to play the target video in the message display region.

In this embodiment, when the current target video that needs to be displayed is not a video captured by directly calling the camera through an application program to which the currently displayed session page belongs, that is, when the current target video that needs to be displayed is a video captured by the sender of the target video calling the camera in advance through another application program, the message display region of the target video may be displayed in the second display style as shown in the fourth session message in FIG. 2.

When the current target video that needs to be displayed is not the video captured by calling the camera through the application program to which the currently displayed session page belongs, the electronic device may display the message display region of the target video in the second display style on the session page and display the target video in the message display region. In this manner, when the user wants to watch the target video, the user may trigger the message display region. Correspondingly, when detecting that the user triggers the message display region, the electronic device may play the target video in the message display region.

In the video display method provided in this embodiment, the video message captured by calling the camera through the application software to which the session page belongs and the target video captured in other manners are displayed in different display styles. When the message display region of the target video is displayed in the first display style, the width of the message display region of the target video is adjusted according to the video duration of the target video. When the target video finishes playing and when the trigger operation of switching the display style of the message display region is received or other target videos are played, the playing of the target video is stopped. In this manner, it is convenient for the user to learn the size relationship between the time lengths of different target videos displayed on the session page, the interest of the user in capturing the video by using the application software to which the session page belongs can be improved. Moreover, it can be ensured that the playing of the target video does not interrupt the user browsing messages or chatting, thereby improving the user experience.

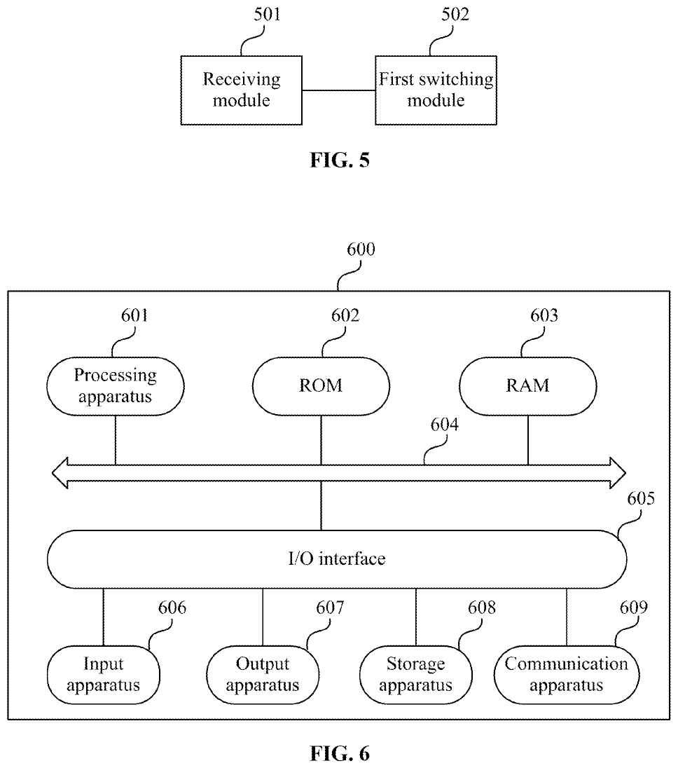

FIG. 5 is a block diagram of a video display apparatus according to an embodiment of the present disclosure. The apparatus may be implemented in software and/or hardware and may be configured in an electronic device such as a mobile phone or a tablet computer. The apparatus may perform a video display method to display a video message. As shown in FIG. 5, the video display apparatus provided in this embodiment may include a receiving module 501 and a first switching module 502.

The receiving module 501 is configured to receive a first trigger operation acting on a first message display region on a session page, where the first message display region is displayed in a first display style, and video description information of a first target video is displayed in the first message display region. The first switching module 502 is configured to, in response to the first trigger operation, switch the first message display region from the first display style to a second display style and play the first target video in the switched first message display region.

In the video display apparatus provided in this embodiment, the receiving module 501 receives the first trigger operation acting on the first message display region on the session page, where the first message display region is displayed in the first display style, and the video description information of the first target video is displayed in the first message display region; and in response to the first trigger operation, the first switching module 502 switches the first message display region from the first display style to the second display style and plays the first target video in the switched first message display region. In the embodiment of the present disclosure, the preceding technical solution is adopted so that different display styles can be used to display the video message, thereby improving the conversation experience of the user.

In the preceding solution, the first switching module 502 may be configured to expand the dimension of the first message display region to switch the first message display region from the first display style to the second display style.

In the preceding solution, the first switching module 502 may include a width expansion unit and/or a height expansion unit. The width expansion unit is configured to move a target boundary line of the first message display region in a direction of expanding the width of the first message display region until the target boundary line is spaced apart from a corresponding boundary line of the session page by a preset distance, where the target boundary line is a left boundary line or a right boundary line. The height expansion unit is configured to move a lower boundary line of the first message display region downward until the dimension ratio of the first message display region matches the dimension ratio of a video frame of the first target video.

The video display apparatus provided in this embodiment may further include a second switching module. The second switching module is configured to, after the first target video is played in the switched first message display region, when the first target video finishes playing or when a second trigger operation for switching a display style of the first message display region is received, switch the first message display region from the second display style to the first display style and stop playing the first target video: or after the first target video is played in the switched first message display region, when a third trigger operation acting on a second message display region displayed in the first display style is received, switch the first message display region from the second display style to the first display style and stop playing the first target video; and switch the second message display region from the first display style to the second display style and play a second target video corresponding to the second message display region in the switched second message display region.

The video display apparatus provided in this embodiment may further include a first display module. The first display module is configured to, before the first trigger operation acting on the first message display region on the session page is received, display a message display region of a target video in the first display style on the session page and display video description information of the target video in the message display region, where the target video includes the first target video.

In the preceding solution, the first display module may include a width determination unit and a region creation unit. The width determination unit is configured to determine the width value of the message display region of the target video according to the video duration of the target video. The region creation unit is configured to create the message display region according to the width value and a preset height value.

The video display apparatus provided in this embodiment may further include a determination module. The determination module is configured to, before the message display region of the target video is displayed in the first display style on the session page, determine that the target video is a video captured by calling a camera through an application software to which the session page belongs.

The video display apparatus provided in this embodiment may further include a second display module. The second display module is configured to, in the case where the target video is not the video captured by calling the camera through the application software to which the session page belongs, display the message display region of the target video in the second display style on the session page to play the target video in the message display region.

The video display apparatus provided in the embodiment of the present disclosure may perform the video display method provided in any embodiment of the present disclosure and has corresponding function modules and effects of the executed video display method. For technical details not described in detail in this embodiment, reference may be made to the video display method provided in any embodiment of the present disclosure.

Referring to FIG. 6, FIG. 6 is a structural diagram of an electronic device (for example, a terminal device) 600 suitable for implementing the embodiments of the present disclosure. The terminal device in the embodiments of the present disclosure may include, but is not limited to, a mobile terminal such as a mobile phone, a laptop, a digital broadcast receiver, a personal digital assistant (PDA), a portable Android device (PAD), a portable media player (PMP) and an in-vehicle terminal (such as an in-vehicle navigation terminal) and a stationary terminal such as a digital television (TV) and a desktop computer. The electronic device shown in FIG. 6 is an example and is not intended to limit the function and use range of the embodiments of the present disclosure.

As shown in FIG. 6, the electronic device 600 may include a processing apparatus (such as a central processing unit and a graphics processing unit) 601. The processing apparatus 601 may execute various appropriate actions and processing according to a program stored in a read-only memory (ROM) 602 or a program loaded into a random-access memory (RAM) 603 from a storage apparatus 608. The RAM 603 also stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 such as a touch screen, a touchpad, a keyboard, a mouse, a camera, a microphone, an accelerometer, and a gyroscope: an output apparatus 607 such as a liquid crystal display (LCD), a speaker, and a vibrator: the storage apparatus 608 such as a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, not all the apparatuses shown here need to be implemented or present. Alternatively, more or fewer apparatuses may be implemented.

According to embodiments of the present disclosure, the processes described in the preceding with reference to the flowcharts may be implemented as computer software programs. For example, an embodiment of the present disclosure includes a computer program product. The computer program product includes a computer program carried on a non-transitory computer-readable medium. The computer program includes program codes for performing the methods illustrated in the flowcharts. In such an embodiment, the computer program may be downloaded from a network and installed through the communication apparatus 609, or may be installed from the storage apparatus 608, or may be installed from the ROM 602. When the computer program is executed by the processing apparatus 601, the preceding functions defined in the method of the embodiments of the present disclosure are performed.

The preceding computer-readable medium of the present disclosure may be a computer-readable signal medium or a computer-readable storage medium or any combination thereof. The computer-readable storage medium may be, but is not limited to, for example, an electronic, magnetic, optical, electromagnetic, infrared, or semiconductor system, apparatus, or device, or any combination thereof. Examples of the computer-readable storage medium may include, but are not limited to, an electrical connection having one or more wires, a portable computer disk, a hard disk, a RAM, a ROM, an erasable programmable read-only memory (EPROM), a flash memory, an optical fiber, a portable compact disc read-only memory (CD-ROM), an optical memory device, a magnetic memory device, or any suitable combination thereof. In the present disclosure, the computer-readable storage medium may be any tangible medium including or storing a program. The program may be used by or in conjunction with an instruction execution system, apparatus, or device. In the present disclosure, the computer-readable signal medium may include a data signal propagated in the baseband or as part of a carrier wave, where computer-readable program codes are carried in the data signal. The data signal propagated in this manner may be in various forms, including, but not limited to, an electromagnetic signal, an optical signal, or any appropriate combination thereof. The computer-readable signal medium may also be any computer-readable medium other than the computer-readable storage medium. The computer-readable signal medium may send, propagate or transmit a program used by or in conjunction with an instruction execution system, apparatus, or device. The program codes included in the computer-readable medium may be transmitted in any suitable medium, including, but not limited to, a wire, an optical cable, a radio frequency (RF), or any suitable combination thereof.

In some embodiments, clients and servers may communicate using any network protocol currently known or developed in the future, such as the Hypertext Transfer Protocol (HTTP), and may be interconnected with any form or medium of digital data communication (for example, a communication network). Examples of the communication network include a local area network (LAN), a wide area network (WAN), an internet (for example, the Internet), a peer-to-peer network (for example, an Ad-Hoc network), and any network currently known or to be developed in the future.

The preceding computer-readable medium may be included in the preceding electronic device or may exist alone without being assembled into the electronic device.

The computer-readable medium carries one or more programs which, when executed by the electronic device, cause the electronic device to, receive a first trigger operation acting on a first message display region on a session page, where the first message display region is displayed in a first display style, and video description information of a first target video is displayed in the first message display region; and in response to the first trigger operation, switch the first message display region from the first display style to a second display style and play the first target video in the switched first message display region.

Computer program codes for performing the operations in the present disclosure may be written in one or more programming languages or a combination thereof. The preceding one or more programming languages include, but are not limited to, object-oriented programming languages such as Java, Smalltalk, and C++, as well as conventional procedural programming languages such as C or similar programming languages. The program codes may be executed entirely on a user computer, executed partly on a user computer, executed as a stand-alone software package, executed partly on a user computer and partly on a remote computer, or executed entirely on a remote computer or a server. In the case involving the remote computer, the remote computer may be connected to the user computer through any type of network including a LAN or a WAN or may be connected to an external computer (for example, via the Internet through an Internet service provider).

The flowcharts and block diagrams in the drawings illustrate possible architectures, functions, and operations of the system, method, and computer program product according to the embodiments of the present disclosure. In this regard, each block in the flowcharts or block diagrams may represent a module, a program segment, or part of codes. The module, program segment, or part of codes contains one or more executable instructions for implementing specified logical functions. It is also to be noted that in some alternative implementations, the functions marked in the blocks may be implemented in an order different from those marked in the drawings. For example, two successive blocks may, in fact, be performed substantially in parallel or in a reverse order, which depends on the functions involved. It is also to be noted that each block in the block diagrams and/or flowcharts and a combination of blocks in the block diagrams and/or flowcharts may be implemented by a special-purpose hardware-based system which performs specified functions or operations or a combination of special-purpose hardware and computer instructions.

The units involved in the embodiments of the present disclosure may be implemented by software or hardware. The name of a module is not intended to limit the unit itself in a certain circumstance.

The functions described herein may be performed, at least partially, by one or more hardware logic components. For example, without limitations, exemplary types of hardware logic components that may be used include a field programmable gate array (FPGA), an application-specific integrated circuit (ASIC), an application specific standard product (ASSP), a system on a chip (SoC), and a complex programmable logic device (CPLD).

In the context of the present disclosure, a machine-readable medium may be a tangible medium that may include or store a program used by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any appropriate combination thereof. Examples of the machine-readable storage medium may include an electrical connection based on one or more wires, a portable computer disk, a hard disk, a RAM, a ROM, an EPROM or a flash memory, an optical fiber, a CD-ROM, an optical storage device, a magnetic storage device, or any suitable combination thereof.

According to one or more embodiments of the present disclosure, example one provides a video display method. The video display method includes the steps described below:

A first trigger operation acting on a first message display region on a session page is received, where the first message display region is displayed in a first display style, and video description information of a first target video is displayed in the first message display region.

In response to the first trigger operation, the first message display region is switched from the first display style to a second display style and the first target video is played in the switched first message display region.

According to one or more embodiments of the present disclosure, according to the method in example one, in example two, the step of switching the first message display region from the first display style to the second display style includes the step described below.

The dimension of the first message display region is expanded so as to switch the first message display region from the first display style to the second display style.

According to one or more embodiments of the present disclosure, according to the method in example two, in example three, the step of expanding the dimension of the first message display region includes the steps described below.

A target boundary line of the first message display region is moved in a direction of expanding the width of the first message display region until the target boundary line is spaced apart from a corresponding boundary line of the session page by a preset distance, where the target boundary line is a left boundary line or a right boundary line.

Moreover/alternatively, a lower boundary line of the first message display region is moved downward until the dimension ratio of the first message display region matches the dimension ratio of a video frame of the first target video.

According to one or more embodiments of the present disclosure, according to the method in example two, in example four, after the first target video is played in the switched first message display region, the method further includes the steps described below.

When the first target video finishes playing or when a second trigger operation for switching a display style of the first message display region is received, the first message display region is switched from the second display style to the first display style and the playing of the first target video is stopped.

Alternatively, when a third trigger operation acting on a second message display region displayed in the first display style is received, the first message display region is switched from the second display style to the first display style and the playing of the first target video is stopped; and the second message display region is switched from the first display style to the second display style and a second target video corresponding to the second message display region is played in the switched second message display region.

According to one or more embodiments of the present disclosure, according to the method in any one of examples one to four, in example five, before the first trigger operation acting on the first message display region on the session page is received, the method further includes the step described below:

A message display region of a target video is displayed in the first display style on the session page and video description information of the target video is displayed in the message display region, where the target video includes the first target video.

According to one or more embodiments of the present disclosure, according to the method in example five, in example six, the step of displaying the message display region of the target video in the first display style on the session page includes the steps described below.

The width value of the message display region of the target video is determined according to the video duration of the target video.

The message display region is created according to the width value and a preset height value.

According to one or more embodiments of the present disclosure, according to the method in example five, in example seven, before the message display region of the target video is displayed in the first display style on the session page, the method further includes the step described below.

It is determined that the target video is a video captured by calling a camera through an application software to which the session page belongs.

According to one or more embodiments of the present disclosure, according to the method in example seven, in example eight, the method further includes the step described below.

In the case where the target video is not the video captured by calling the camera through the application software to which the session page belongs, the message display region of the target video is displayed in the second display style on the session page so as to play the target video in the message display region.

According to one or more embodiments of the present disclosure, example nine provides a video display apparatus. The video display apparatus includes a receiving module and a first switching module.

The receiving module is configured to receive a first trigger operation acting on a first message display region on a session page, where the first message display region is displayed in a first display style, and video description information of a first target video is displayed in the first message display region.

The first switching module is configured to, in response to the first trigger operation, switch the first message display region from the first display style to a second display style and play the first target video in the switched first message display region.

According to one or more embodiments of the present disclosure, example ten provides an electronic device. The electronic device includes one or more processors and a memory configured to store one or more programs.

When executed by the one or more processors, the one or more programs cause the one or more processors to perform the video display method in any one of examples one to eight.

According to one or more embodiments of the present disclosure, example eleven provides a computer-readable storage medium. The storage medium stores a computer program which, when executed by a processor, causes the processor to perform the video display method in any one of examples one to eight.

Additionally, although multiple operations are described in a particular order, it is not a must to perform these operations in this particular order or in sequential order. In certain circumstances, multitasking and parallel processing may be advantageous. Similarly, although multiple implementation details are included in the preceding discussion, these should not be construed as limiting the scope of the present disclosure. Some features described in the context of separate embodiments may be implemented in combination in a single embodiment. Rather, features described in the context of a single embodiment may also be implemented in multiple embodiments separately or in any appropriate sub-combination.

1. A video display method, comprising:
receiving a first trigger operation acting on a first message display region on a session page, wherein the first message display region is displayed in a first display style, and video description information of a first target video is displayed in the first message display region; and
in response to the first trigger operation, switching the first message display region from the first display style to a second display style and playing the first target video in the switched first message display region.

2. The method of claim 1, wherein switching the first message display region from the first display style to the second display style comprises:
expanding a dimension of the first message display region to switch the first message display region from the first display style to the second display style.

3. The method of claim 2, wherein expanding the dimension of the first message display region comprises at least one of the following:
moving a target boundary line of the first message display region in a direction of expanding a width of the first message display region until the target boundary line is spaced apart from a corresponding boundary line of the session page by a preset distance, wherein the target boundary line is a left boundary line or a right boundary line; or
moving a lower boundary line of the first message display region downward until a dimension ratio of the first message display region matches a dimension ratio of a video frame of the first target video.

4. The method of claim 2, after playing the first target video in the switched first message display region, further comprising:
when the first target video finishes playing or when a second trigger operation for switching a display style of the first message display region is received, switching the first message display region from the second display style to the first display style and stopping playing the first target video; or
when a third trigger operation acting on a second message display region displayed in the first display style is received, switching the first message display region from the second display style to the first display style and stopping playing the first target video; and switching the second message display region from the first display style to the second display style and playing a second target video corresponding to the second message display region in the switched second message display region.

5. The method of claim 1, before receiving the first trigger operation acting on the first message display region on the session page, further comprising:
displaying a message display region of a target video in the first display style on the session page and displaying video description information of the target video in the message display region, wherein the target video comprises the first target video.

6. The method of claim 5, wherein displaying the message display region of the target video in the first display style on the session page comprises:
determining a width value of the message display region of the target video according to a video duration of the target video; and
creating the message display region according to the width value and a preset height value.

7. The method of claim 5, before displaying the message display region of the target video in the first display style on the session page, further comprising:
determining that the target video is a video captured by calling a camera through an application software to which the session page belongs.

8. The method of claim 7, further comprising:
in a case where the target video is not the video captured by calling the camera through the application software to which the session page belongs, displaying the message display region of the target video in the second display style on the session page to play the target video in the message display region.

9. A video display apparatus, comprising:
at least one processor; and
a memory configured to store at least one program;
wherein when executed by the at least one processor, the at least one program causes the at least one processor to:
receive a first trigger operation acting on a first message display region on a session page, wherein the first message display region is displayed in a first display style, and video description information of a first target video is displayed in the first message display region; and
in response to the first trigger operation, switch the first message display region from the first display style to a second display style and play the first target video in the switched first message display region.

10. (canceled)

11. A non-transitory computer-readable storage medium storing a computer program which, when executed by a processor, causes the processor to:
receive a first trigger operation acting on a first message display region on a session page, wherein the first message display region is displayed in a first display style, and video description information of a first target video is displayed in the first message display region; and
in response to the first trigger operation, switch the first message display region from the first display style to a second display style and play the first target video in the switched first message display region.

12. The method of claim 2, before receiving the first trigger operation acting on the first message display region on the session page, further comprising:
displaying a message display region of a target video in the first display style on the session page and displaying video description information of the target video in the message display region, wherein the target video comprises the first target video.

13. The method of claim 3, before receiving the first trigger operation acting on the first message display region on the session page, further comprising:
displaying a message display region of a target video in the first display style on the session page and displaying video description information of the target video in the message display region, wherein the target video comprises the first target video.

14. The method of claim 4, before receiving the first trigger operation acting on the first message display region on the session page, further comprising:
displaying a message display region of a target video in the first display style on the session page and displaying video description information of the target video in the message display region, wherein the target video comprises the first target video.

15. The apparatus of claim 9, wherein the at least one processor is caused to switch the first message display region from the first display style to the second display style in the following manner:
expanding a dimension of the first message display region to switch the first message display region from the first display style to the second display style.

16. The apparatus of claim 15, wherein the at least one processor is caused to expand the dimension of the first message display region in at least one of the following manners:
moving a target boundary line of the first message display region in a direction of expanding a width of the first message display region until the target boundary line is spaced apart from a corresponding boundary line of the session page by a preset distance, wherein the target boundary line is a left boundary line or a right boundary line; or
moving a lower boundary line of the first message display region downward until a dimension ratio of the first message display region matches a dimension ratio of a video frame of the first target video.

17. The apparatus of claim 15, after playing the first target video in the switched first message display region, the at least one processor is further caused to:
when the first target video finishes playing or when a second trigger operation for switching a display style of the first message display region is received, switch the first message display region from the second display style to the first display style and stopping playing the first target video; or
when a third trigger operation acting on a second message display region displayed in the first display style is received, switch the first message display region from the second display style to the first display style and stopping playing the first target video; and switch the second message display region from the first display style to the second display style and playing a second target video corresponding to the second message display region in the switched second message display region.

18. The apparatus of claim 9, before receiving the first trigger operation acting on the first message display region on the session page, the at least one processor is further caused to:
display a message display region of a target video in the first display style on the session page and displaying video description information of the target video in the message display region, wherein the target video comprises the first target video.

19. The apparatus of claim 18, wherein the at least one processor is caused to display the message display region of the target video in the first display style on the session page in the following manners:
determining a width value of the message display region of the target video according to a video duration of the target video; and
creating the message display region according to the width value and a preset height value.

20. The apparatus of claim 18, wherein before displaying the message display region of the target video in the first display style on the session page, the at least one processor is further caused to:
determine that the target video is a video captured by calling a camera through application software to which the session page belongs.

21. The apparatus of claim 20, the at least one processor is further caused to:
in a case where the target video is not the video captured by calling the camera through the application software to which the session page belongs, display the message display region of the target video in the second display style on the session page to play the target video in the message display region.
